(19) United States
(12) Patent Application Publication
(10) Pub. No.: US 2007/0208702 A1
(43) Pub. Date: Sep. 6, 2007

(54) Method and system for delivering published information associated with a tuple using a pub/sub protocol

(76) Inventor: Robert P. Morris, Raleigh, NC (US)

Correspondence Address: SCENERA RESEARCH, LLC, 111 Corning Road, Suite 220, Cary, NC, 27518, US

(21) Appl. No.: 11/366,792

(22) Filed: Mar. 2, 2006

(51) Int. Cl. G06F 17/30

(52) U.S. Cl. 707/3

(57) ABSTRACT

A method for delivering published information associated with a tuple using a pub/sub communication protocol includes receiving partitioning information associated with the tuple and using the partitioning information to define a plurality of distinct tuple elements. Each distinct tuple element corresponds to a portion of the published information associated with the tuple. A series of notification messages is sent to a recipient client where each notification message is associated with one of the plurality of distinct tuple elements for providing each related portion of the published information to the recipient client.

### RELATED APPLICATIONS

The present application is related to co-pending U.S. patent application Ser. No. 11/306,341, entitled “METHODS, SYSTEMS, AND COMPUTER PROGRAM PRODUCTS FOR ASSOCIATING POLICIES WITH TUPLES USING A PUB/SUB PROTOCOL,” filed on Dec. 23, 2005, and assigned to the assignee of the present application. The present application is also related to co-pending U.S. patent application Ser. No. 11/306,346, entitled “METHOD AND SYSTEM FOR PRESENTING PUBLISHED INFORMATION IN A BROWSER,” filed on Dec. 23, 2005, and assigned to the assignee of the present application. Each of the above-cited related applications is incorporated here by reference in its entirety.

### BACKGROUND

Today's more popular browsers, such as MICROSOFT'S INTERNET EXPLORER and MOZILLA FOUNDATION'S FIREFOX, use the HyperText Transport Protocol (HTTP) to exchange information over the Internet. HTTP is a request/response, synchronous, communication protocol, where one entity in a network (e.g., the browser) makes a connection to another network entity (e.g., a web server), sends a request to the other entity, and then waits for a reply from the other entity. Notably, the reply is sent only in response to the request. If a request is not made, a reply is not sent. Accordingly, information received in a reply can become stale.

Another mode of exchanging information over the Internet uses a publish/subscribe (pub/sub), asynchronous, communication protocol. The commands of an asynchronous protocol, such as the pub/sub communication protocol, are structured such that there need not be a one-to-one correspondence between requests and responses exchanged between communication entities. In some cases a sender of information via the protocol need not wait, nor expect a response from, a receiver. Moreover, a receiver need not send a request for each response. That is, a receiver may receive multiple responses to a request and/or may receive an unsolicited message. Thus, unlike HTTP where the reply is sent directly (synchronously) and only in response to the entity's request, the information can instead be sent in response to the sender's posting of the information (i.e., asynchronous to the request of information).

According to the pub/sub communications protocol, an entity, referred to as a subscriber or subscriber client, is allowed to subscribe to information provided by another entity, referred to as a publisher, via a pub/sub service. Publishers publish to a distinct ID, typically a uniform resource identifier (URI) or uniform resource locator URL, and subscribers subscribe by providing the ID. The publisher posts, i.e., publishes, the information to the pub/sub service identifying the tuple to be created or updated, the service then transmits the published tuple information to all interested parties, i.e., subscribers, via notification messages. The published information can be read simultaneously by any number of subscribers. So long as the subscriber remains subscribed to the information, the subscriber will continue to receive notification messages corresponding to the publisher's postings.

Notably, as is used herein, the term “publish/subscribe” refers to the class of services and associated protocols where a subscriber receives only the most recently published information in a notification message resulting from a subscription. That is, the pub/sub service transmits to the subscriber only the most current state of the published information, and does not queue, or store, previously published data for retrieval when the subscriber is offline or otherwise unsubscribed, such as with email and traditional message queues. Thus, unlike typical message queuing services, when a subscriber logs on or subscribes to the pub/sub service, the subscriber receives only the current state of the information, as well as subsequent updates to the information while the subscriber is subscribed. The subscriber does not receive previous updates that may have occurred while the subscriber was offline or unsubscribed. In addition, the pub/sub services as described herein are not topic based subscription services where typically any number of publishers may contribute to a single subscription. In topic based subscription services, whether a published entity is sent to a subscriber is based on its topic or categorization. Such topic based subscription services are also sometimes referred to as pub/sub services.

Well known pub/sub communication protocols include presence protocols, such as XMPP-IM, SIP SIMPLE, and RVP, which are used by presence services and Jabber Software Foundation's pub/sub protocol as specified in Jabber Enhancement Proposal (JEP) JEP0060: Publish-Subscribe. The architecture, models, and protocols associated with presence services in general are described in “Request for Comments” (or RFC) documents RFC 2778 to Day et al., titled “A Model for Presence and Instant Messaging” (February 2000), RFC 2779 to Day et al., titled “Instant Messaging/Presence Protocol” (February 2000), and RFC 3921 to Saint-Andre et. al, titled “Extensible Messaging and Presence Protocol (XMPP): Instant Messaging and Presence”, each of which are published and owned by the Internet Society and incorporated here in their entirety by reference.

According to the pub/sub communication protocol, the pub/sub service stores and organizes information provided by the publisher and by the subscriber in data entities referred to as tuples. A tuple, in its broadest sense, is a data object containing one or more elements. If a tuple contains a status element it is referred to as a presence tuple (RFC 2778) or presence information. A pub/sub service which processes presence tuples is referred to as a presence service. In addition to containing a status element, a presence tuple can include any other content. Typically, presence tuples contain one or more contact elements for storing the contact information associated with the owner of the presence tuple, as well as other elements for storing other information.

Typical Internet-enabled devices, such as laptop and desktop computers that run powerful processors, include substantial memory resources, and have access to high-speed Internet connections, allow users of such devices to reap the benefits of the pub/sub service described above. In addition, because more and more small, handheld devices are now Internet-enabled, users of such devices can enjoy mobile access to the Internet, and therefore, the services offered by the pub/sub service.

These small, handheld devices, however, typically lack the resources found in the larger devices, e.g., the laptop or desktop computer. In particular, small handheld devices typically lack substantial memory resources, processing power or reliable and high-speed Internet service. Thus, when the pub/sub service sends a large tuple to a small handheld device in accordance with a subscription to the tuple, the handheld device may have difficulty processing the tuple because it may not have enough memory to store the entire tuple. In addition, even if the device has sufficient memory, the time required to receive the entire tuple can be excessive, thereby annoying the user and increasing the likelihood of an unsuccessful transmission.

In response to this problem, developers have proposed a mechanism where the pub/sub service is configured to determine the updated elements of a tuple and to send a notification message including only the updated elements to the subscriber. See, e.g., Internet Draft of the IETF entitled, “Session Initiation Protocol (SIP) Extension for Partial Notification of Presence Information,” by Lonnfors et al., Oct. 21, 2005 (http://www.ietf.org/internet-drafts/draft-ietf-simple-partial-notify-06.txt) and Internet Draft of the IETF entitled, “Presence Information Data format (PIDF) Extension for Partial Presence” by Lonnfors et al., Oct. 21, 2005 (http://www.ietf.org/internet-drafts/draft-ietf-simple-partial-pidf-format-05.txt). This approach, however, does not provide relief if the updated tuple element itself or the number of updated tuple elements is large. In both cases, the receiving device is required to receive, store and process a large amount of data. Moreover, if related, but unmodified, portions of the tuple are needed to process the updated tuple elements, or if the tuple elements are required to be processed in a particular order, this approach can fail.

### SUMMARY

Accordingly, a system and method for delivering published information associated with a tuple using a pub/sub communication protocol are described. According to an exemplary embodiment, partitioning information associated with the tuple is received by a pub/sub service. The pub/sub service uses the partitioning information to define a plurality of distinct tuple elements. Each distinct tuple element corresponds to a portion of the published information associated with the tuple. The pub/sub service sends a series of notification messages each associated with one of the plurality of distinct tuple elements for providing each related portion of the published information to a recipient client.

According to another exemplary embodiment, a method for receiving information associated with a tuple using a pub/sub communication protocol is described. In this embodiment, a subscriber forms a subscription request to subscribe to the information associated with the tuple and sends the request to a pub/sub service that manages the tuple. The subscriber then receives a series of notification messages from the pub/sub service based on the subscription request. Each notification message is associated with one of a plurality of distinct tuple elements, each of which corresponds to a portion of the published information associated with the tuple.

According to another exemplary embodiment, a system for delivering published information associated with a tuple using a publish/subscribe communication protocol includes a publisher configured to publish information associated with the tuple, a recipient client configured to receive the published information, and a pub/sub service. The pub/sub service is configured to receive partitioning information associated with the tuple, to define a plurality of distinct tuple elements each related to a portion of the published information associated with the tuple based on the received partitioning information, and to send to the recipient client a series of notification messages each associated with one of the plurality of distinct tuple elements for providing each related portion of the published information to the recipient client.

According to yet another exemplary embodiment, a system for delivering published information associated with a tuple using a publish/subscribe communication protocol includes means for publishing information associated with the tuple, means for defining a plurality of distinct tuple elements each corresponding to a portion of the published information associated with the tuple based on partitioning information, and means for sending to a recipient client a series of notification messages each associated with one of the plurality of distinct tuple elements for providing each related portion of the published information to the recipient client.

According to another exemplary embodiment, a system for receiving information associated with a tuple using a publish/subscribe communication protocol includes means for forming a subscription request to subscribe to the information associated with the tuple, means for providing partitioning information related to the tuple in the subscription request, means for sending the subscription request to a publish/subscribe service that manages the tuple, and means for receiving a series of notification messages from the publish/subscribe service based on the subscription request. Each notification message is associated with one of a plurality of distinct tuple elements, each of which is related to a portion of the published information associated with the tuple.

According to yet another exemplary embodiment, a device for receiving information associated with a tuple using a publish/subscribe communication protocol includes a subscription client component configured to form a subscription request to subscribe to the information associated with the tuple and to include partitioning information related to the tuple in the subscription request, and a network stack component configured to send the subscription request and partitioning information to a publish/subscribe service that manages the tuple, and to receive a series of notification messages from the publish/subscribe service based on the subscription request. The partitioning information is used to define a plurality of distinct tuple elements, each of which is related to a portion of the published information associated with the tuple. Each notification message is associated with one of the plurality of distinct tuple elements.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a block diagram illustrating an exemplary system for delivering published information associated with a tuple via a pub/sub server according to an exemplary embodiment;

FIG. 2 is a block diagram illustrating an exemplary pub/sub service according to an exemplary embodiment;

FIG. 3 is a block diagram illustrating an exemplary tuple structure in a system for delivering published information associated with a tuple according to one embodiment;

FIG. 4A and 4B illustrate exemplary queue tuples where partitioning is controlled by a publisher application according to exemplary embodiments;

FIG. 5 is a block diagram illustrating another exemplary tuple structure in a system for delivering published information associated with a tuple according to another embodiment;

FIG. 6 is a block diagram illustrating an exemplary pub/sub protocol agent where the pub/sub protocol used is the presence protocol;

FIG. 7 is a flow diagram illustrating a method for delivering published information associated with a tuple using a pub/sub protocol according to an exemplary embodiment; and

FIG. 8 is a flow diagram illustrating a method for receiving information associated with a tuple using a pub/sub protocol according to an exemplary embodiment.

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

According to an exemplary embodiment, a method and system for delivering published information associated with a tuple using a pub/sub protocol is described. A pub/sub communication architecture and its underlying messaging protocol allow published information to be sent to a subscriber as it is received, in many instances, substantially in real-time in relation to the publication of the information. Information is published within the pub/sub communication architecture using a publish command. The published information can then be communicated to a subscriber using a notify command. The notify command can either include the published information or can provide a reference to the published information. Accordingly, every notify command corresponds to exactly one publish command in current pub/sub communication architectures.

By way of example, aspects of exemplary embodiment described here can employ a presence protocol as the pub/sub communications protocol. It should be understood, however, the relevant techniques described here can be performed using any pub/sub communications protocol as defined herein. Additionally, the exemplary embodiment described herein is not limited to the use of a pub/sub protocol for all communications described. Other known protocol can also be used.

Generally speaking, one or more pub/sub servers are used to provide pub/sub services. The function of a pub/sub server, however, can be incorporated, either in whole or in part, into other entities. For example, the presence service model can be used. The presence service model described in RFC 2778 describes two distinct agents of a presence service client. The first of these agents, called a “presentity” (combining the terms “presence” and “entity”), provides presence information to be stored and distributed throughout the presence service on behalf of a presence client. The second type of presence agent is referred to as a “watcher”. Watchers receive presence information from a presence service on behalf of a presence client.

The presence model of RFC 2778 describes two types of watchers, referred to as “subscribers” and “fetchers”. A subscriber requests notification from the presence service of a change in some presentity client's presence information. The presence service establishes a subscription on behalf of the subscriber to a presentity client's presence information, such that future changes in the presentity client's presence information are “pushed” to the subscriber. In contrast, the fetcher class of watchers requests (or fetches) the current value of some presentity client's presence information from the presence service. As such, the presence information can be said to be “pulled” from the presence service to the watcher.

Users of the presence service are referred to in the presence model described in RFC 2778 as principals. Typically, a principal is a person or group that exists outside of the presence model, but can also represent software or other resources capable of interacting with the presence service. A principal can interact with the presence system through a presence user agent (PUA) or a watcher user agent (WUA). As in the case of the presentity and watcher clients with which these service clients interact, the presence and watcher user agents can be combined functionally as a single user agent having both the characteristics of the presence and watcher user agents. User agents can be implemented such that their functionality exists within a presence service, external to a presence service, or a combination of both. Similar statements can be made about presentities and watchers.

As mentioned above, a pub/sub (or presence) service typically stores and organizes published information into tuples. A tuple can represent any element used to store the published information associated with a resource, e.g., a publisher/principal. The published information may include general contact information for the network resource, such as name, telephone number, email address, postal address, an IP addresses or URLs associated with the resource, and the like, as well as other data or content. If the published information associated with the principal also includes status information, then the published information may be referred to as presence information. As used here, the tuple can also be a representation that maps field names to certain values to indicate that an entity or object (e.g., the principal) includes certain components, information, and/or perhaps has certain properties.

According to aspects of an exemplary embodiment described herein, a plurality of distinct tuple elements is defined based on partitioning information provided by at least one of the subscriber, the publisher and the pub/sub service. Each distinct tuple element is related to a portion of the published information in the tuple. When the published information associated with the tuple is “pushed” to the subscriber as a result of a new subscription or an update to the tuple, the published information is sent to the subscriber in a series of notification messages, where each notification message is associated with one of the plurality of distinct tuple elements. By sending the published information in the series of notification messages, recipient clients with limited resources can receive and process the information incrementally thereby improving performance and response time.

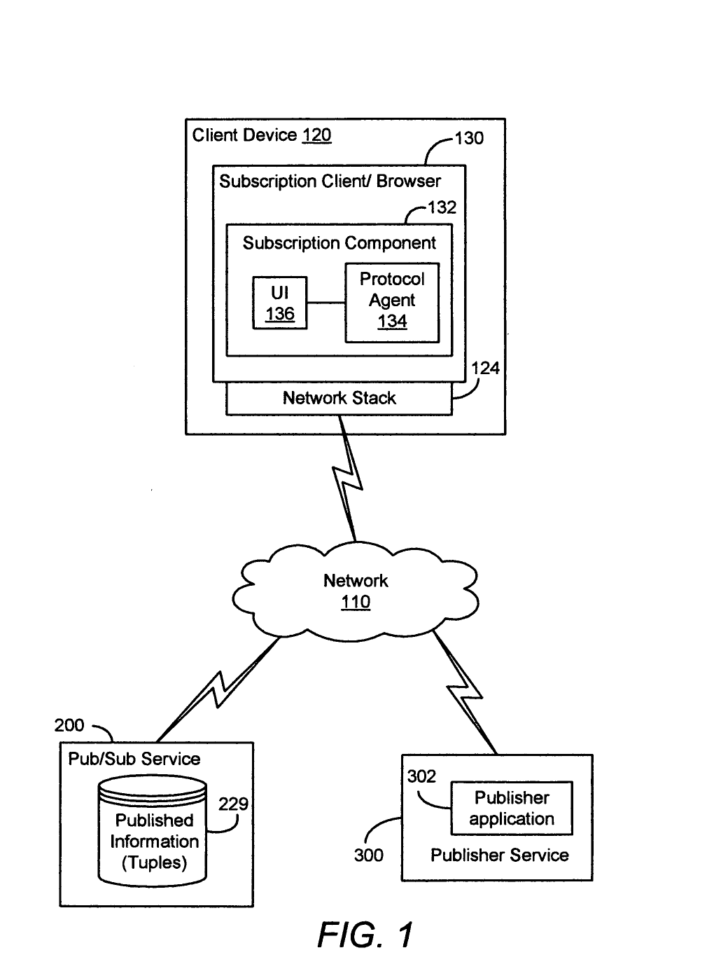

FIG. 1 is a block diagram illustrating an exemplary system for delivering published information associated with a tuple using a pub/sub protocol according to an exemplary embodiment. The system 100 includes a client device 120 in communication with a pub/sub service 200 and a publisher service 300. The client device 120 may be any electronic device that includes a network stack 124 for communicating over a network 110. Example types of such computing devices include a camera phone, a personal digital assistant (PDA), a personal computer (PC), network-enabled camera, and the like.

Each client device 120 includes at least one pub/sub client 130, such as a subscriber client that is configured to communicate via a pub/sub protocol with the pub/sub service 200. In one embodiment, the subscriber client can be a subscription browser, as disclosed in co-pending U.S. patent application Ser. No. 11/160,612 entitled “METHOD AND APPRATUS FOR BROWSING NETWORK RESOURCES USING AN ASYNCHRONOUS COMMUNICATIONS PROTOCOL,” filed on Jun. 30, 2005, assigned to the assignee of the present application, and herein incorporated by reference. The subscription browser 130 makes use of an architecture similar to standard Web browsers, such as MICROSOFT'S INTERNET EXPLORER or MOZILLA FOUNDATION'S FIREFOX, but the subscription browser 130 is further provided with a means for enabling the subscription browser 130 to communicate via a pub/sub protocol with the pub/sub service 200. For example, a subscription component 132 can be configured for enabling the subscription browser 130 to communication with the pub/sub service 200 using a pub/sub protocol. The subscription component 132 can indude a pub/sub protocol agent 134 for managing pub/sub commands to and from the pub/sub service 200 and a user interface component 136 for presenting information received from the pub/sub service 200.

According to an exemplary embodiment, the publisher service 300 can host an application 302 configured to publish information associated with a tuple to the pub/sub service 200 using a pub/sub protocol. Note that other arrangements are contemplated. For example, all messages between the publisher service 300 and the pub/sub service 200 can be exchanged using a request/response (e.g., HTTP) or other synchronous communication protocol. Alternatively, messages sent from the pub/sub service 200 to the publisher service 300 can be carried using one type of protocol (e.g., request/response or HTTP) while messages sent from the publisher service 300 to the pub/sub service 200 can be carried using a different protocol (e.g., pub/sub), and vice versa.

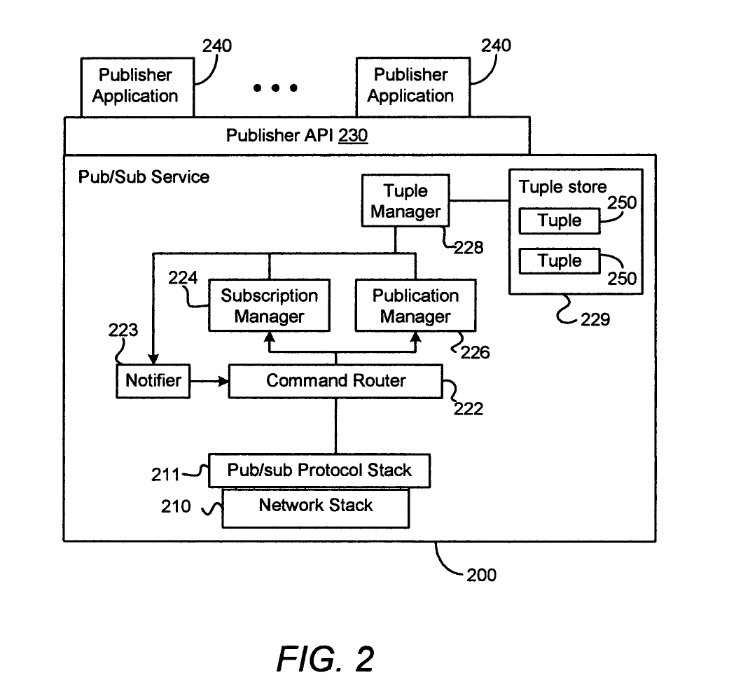

FIG. 2 is an exemplary block diagram of a pub/sub service 200 according to an exemplary embodiment. The pub/sub service 200 indudes a pub/sub protocol stack component 211 coupled to a network stack component 210. The network stack component 210 is used to exchange information received or transmitted at the physical layer (e.g., the wire, air interface, or fiber optic cable) of the network 110, through the data link (e.g., ETHERNET, 802.11 WIFI), transport/network (e.g., TCP/IP) and application (e.g., XMPP) layers of the stack. The pub/sub protocol stack component 211 processes pub/sub commands received from the network 110.

The pub/sub service 200 includes means for receiving and processing pub/sub commands from the pub/sub protocol stack component 211, means for handling subscribe commands, means for handling publish commands, and means for handling notification messages. For example, a command router 222 can be configured to receive and process pub/sub commands from the pub/sub protocol stack component 211. In one embodiment, the command router 222 directs subscribe commands to a subscription manager 224 that is configured to handle subscribe commands, directs publish commands to a publication manager 226 that is configured to handle publish commands, and sends notify commands on behalf of a notifier 223. The command router 222 can also be configured to process other pub/sub commands, such as PROBE and FETCH/POLL.

The subscription manager 224 processes subscribe commands and other tasks associated with subscriptions. In one embodiment, the subscription manager 224 processes a subscribe command by placing the subscribing client 130 on a subscription list associated with the tuple. In addition, the subscription manager 224 authenticates and authorizes the client 130, manages rosters and subscription lists, and uses the notifier 223 to construct notification response messages informing the publisher service 300 of subscription and notification response messages informing clients 130 when new information is available. The publication manager 226 processes publish commands and coordinates with the subscription manager 224 the publication of tuple data to ensure that subscribing clients 130, if any, are notified via the notifier 223.

In one embodiment, the pub/sub service 200 is configured to host one or more publisher applications 240 via a publisher application programming interface (API) 230. Such a configuration is described in co-pending U.S. patent application Ser. No. 11/323,762 entitled “METHOD AND APPARATUS FOR PROVIDING CUSTOMIZED SUBSCRIPTION DATA,” filed on Dec. 30, 2005, and assigned to the assignee of the present application, and herein incorporated by reference. In one embodiment, the publisher API 230 enables the pub/sub service 200 to pass subscription notification messages to any one of the publisher applications 240. Because the publisher API 230 is independent of both the transport and pub/sub protocol, messages can be exchanged freely and securely between the pub/sub service 200 and any of the publisher applications 240.

The pub/sub server 200 further includes means for managing tuples 250 and published information in the tuples 250. For example, a tuple manager 228 can be configured to manage tuples 250 and published information stored in a tuple store 229. In one embodiment, the tuple manager 228 can be configured also to manage rosters for security purposes and to store and to retrieve tuple data from the tuple store 229. If the pub/sub server 200 archives published information, the tuple manager 228 can also be configured to archive and to retrieve the published information.

As stated above, when the pub/sub service 200 receives a publish command for a tuple 250 from a publisher application 240, 302, the pub/sub service 200 updates the tuple 250 and sends one notification message to a recipient client 130 pursuant to a subscription and/or pursuant to a directed publish-notify command from the publisher service 300. The notification message typically includes the entire tuple 250 or only an updated portion thereof, which can pose problems for the client 130 that resides in a device 120 with limited resources. Moreover, neither the publisher application 240, 302 nor the recipient client 130 has control over how the published information is delivered. For example, the recipient client 130 may prefer to receive the published information in a certain order, e.g., ascending or descending by date of creation, or in a certain grouping. With current pub/sub services 200, no such control is possible because the tuple information is delivered “as is” in a single notification message.

According to an exemplary embodiment, published information associated with a tuple 250 can be partitioned into a set of distinct tuple elements, where each distinct tuple element is associated with a distinct portion of the published information. Each distinct tuple element has a well-defined boundary such that the distinct portion of the published information can stand alone. In other words, a client 130 receiving any one distinct tuple element can process it without further tuple information. In one embodiment, each distinct tuple element in the set or a subset of distinct tuple elements can be delivered to the recipient client 130 in a series of notification messages, as opposed to one. Depending on the circumstances, the contents of each distinct tuple element sent can vary according to the publisher's 240, 302 preferences, the recipient's 130 preferences, and/or the preferences of the pub/sub service 200.

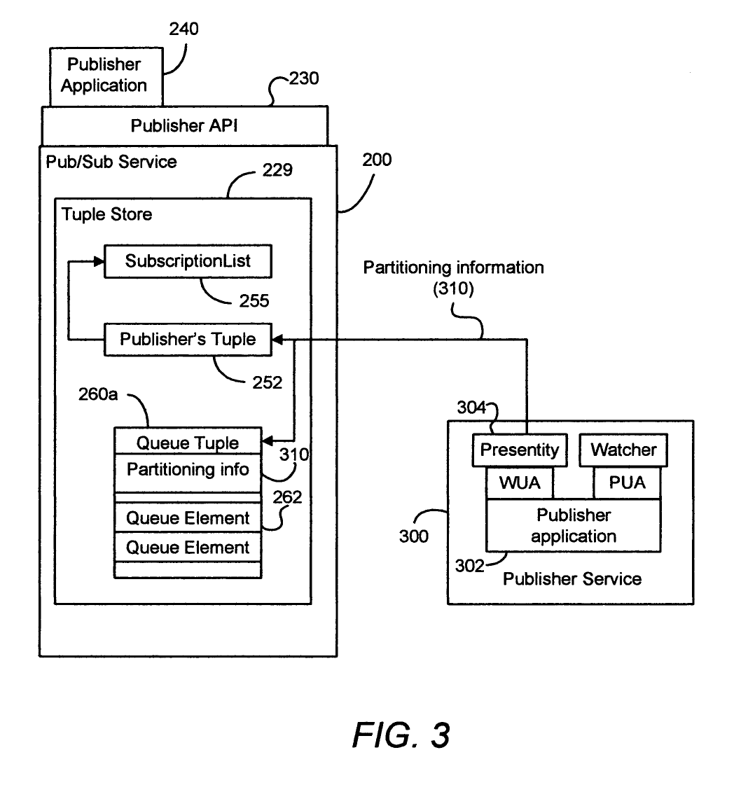

FIG. 3 is a block diagram illustrating an exemplary tuple structure in a system for delivering published information associated with a tuple 250. In this exemplary embodiment, the tuple store 229 includes a publisher's tuple 252 that is related to information published by a publisher 240, 302. The publisher's tuple 252 is associated with a subscription list 255 that includes at least one subscriber client 130 that is subscribed to the information in the publisher's tuple 252.

In the embodiment shown in FIG. 3, the publisher 240, 302 specifies all partitioning parameters for all recipient clients 130 including the subscribers subscribed to the publisher's tuple 252. The publisher application 240, 302 is configured to provide publisher's partitioning information 310 to the pub/sub service 200. Here, the publisher application 302 residing in a publisher service 300 publishes the publisher's partitioning information 310 to the pub/sub service 200 using a pub/sub protocol, such as a presence protocol, via a presentity component 304.

According to an exemplary embodiment, the publisher's partitioning information 310 can define how the published information in the publisher's tuple 252 can be partitioned and also can define which of the distinct tuple elements can be sent to the recipient client 130, i.e., the entire set or a subset. In addition, the publisher's partitioning information 310 can indicate how the plurality of distinct tuple elements can be sent to the recipient client 130. For example, the publisher's partitioning information 310 can specify the order in which each of the distinct tuple elements is sent to the recipient client 130 and how quickly each of the distinct tuple elements is sent.

Below, in Example 1, an exemplary publish command using an XMPP pub/sub protocol that includes partitioning instructions is provided.

### EXAMPLE 1

```
<iq type=“set” from=“rpm@jabber.org”
    to=“pubsub.bigpublisher.com” id=“create1”>
    <pubsub xmlns=“http://jabber.org/protocol/pubsub”>
        <create node=“generic/book” partition=”chapter,section”
            orberBy=”chapter:asc,section=asc”/>
        <configure/>
    </pubsub>
</iq>
```

In this exemplary publish command, the publisher 302, “rpm@jabber.org,” requests the pub/sub service 200, “pubsub.bigpublisher.com,” to create a new node, e.g., a new tuple or subtuple, “generic/book.” The publisher 302 specifies that the published information associated with the new node can be partitioned at “chapter” and “section” elements, and that both can be presented in ascending order.

In one embodiment, the publisher's partitioning information 310 can be stored in the publishers tuple 252. In another embodiment, the publisher's partitioning information 310 can be stored in another tuple, referred to as a publisher's queue tuple 260a. The publisher's queue tuple 260a can be a data tuple that includes a plurality of queue elements 262, each of which represents one of the distinct tuple elements defined by the publisher's partitioning information 310. Each queue element 262 can include the portion of the published information corresponding to the distinct tuple element or a reference, such as a URI, to the portion of the published information.

The queue elements 262 in the queue tuple 260a are associated with the most recent update of the tuple 252. If a new update to the tuple 252 occurs before all the queue elements 262 have been sent, the queue may be purged in one embodiment and new queue elements 262 may be placed in the queue so that the recipient client 130 is sent only current information. In an alternate embodiment, the queue elements 262 may be sent when a new update is received but before the new update is processed. If more than one update to the tuple 252 occurs while a queue tuple 260a is being processed, only the last update will be used to create the next queue of elements because the intermediate updates are no longer current. This is consistent with the definition of a pub/sub service as defined herein. In a further alternate embodiment, the queue elements 262 may be replaced by the latest versions of those elements when a new update is received, then the queue tuple 260a can be repopulated with all the distinct elements to be sent when an update occurs, so that the recipient client 130 has all the latest data.

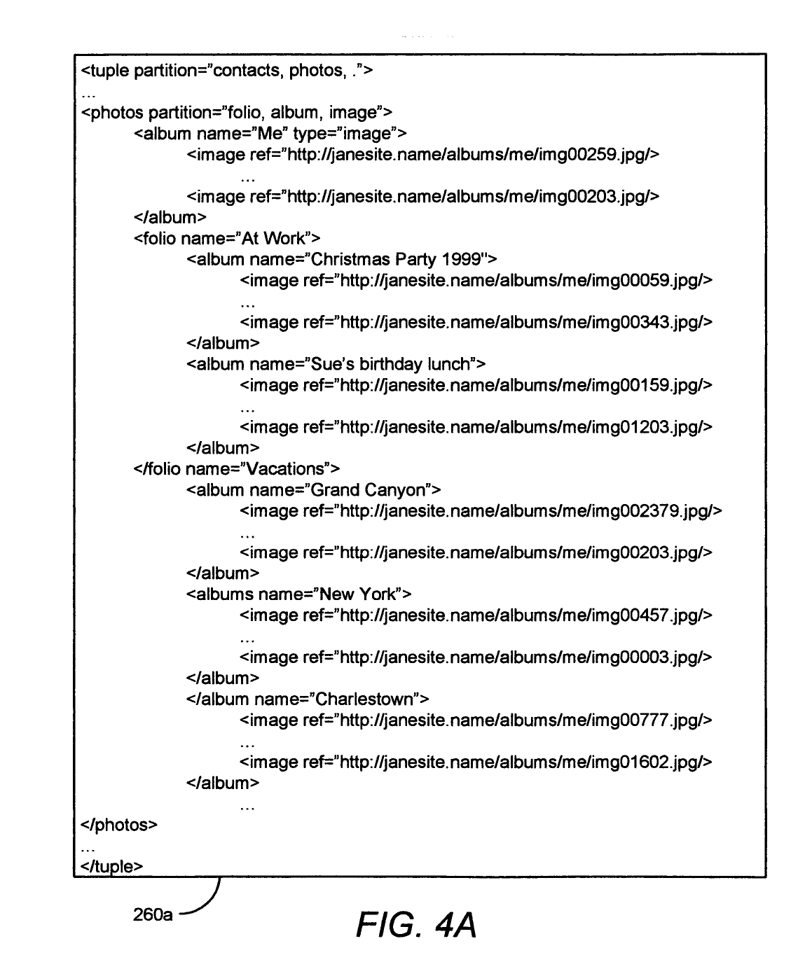

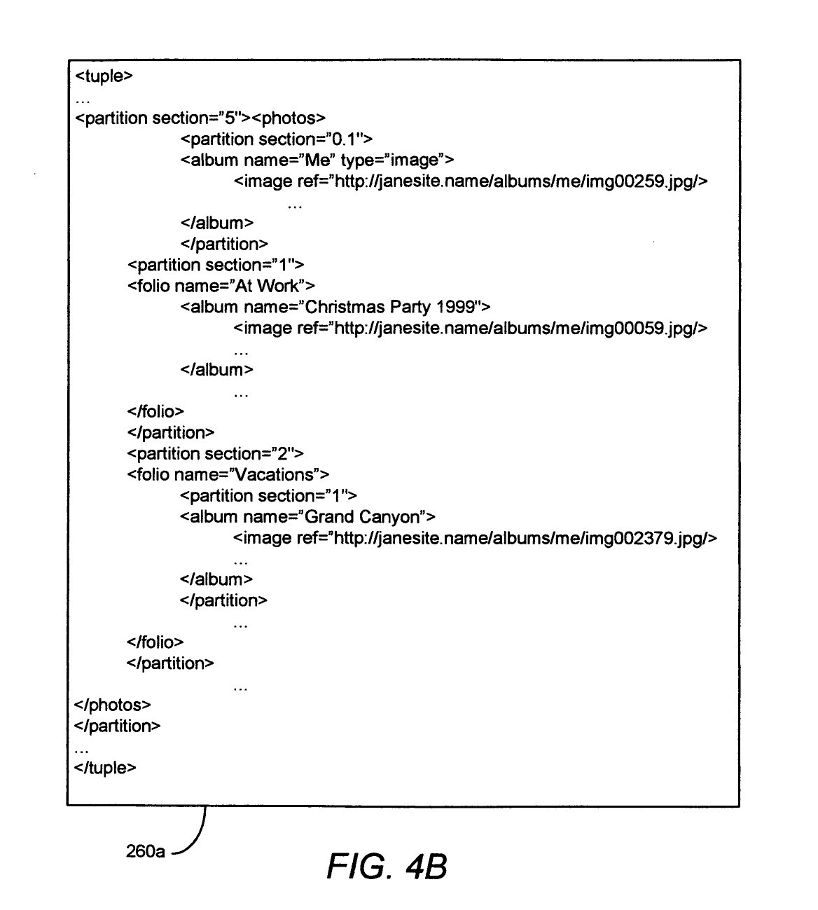

FIG. 4A illustrates an exemplary publisher queue tuple 260a where partitioning is controlled by a publisher application 240, 302 according to one embodiment. As is shown, at each level, an element may specify a “partition” attribute. The attribute may be set to a list of elements contained in the tuple 260a, which may then be used as partition boundaries. In one embodiment, a subtuple may specify additional partition boundaries such that the subtuple can be partitioned as well. For example, a “contacts” element and a “photos” element are designated as partition boundaries. Furthermore, the “photos” element can be further partitioned at “folio” elements, “album” elements, and/or “image” elements. Thus, the granularity of the partitioning can be controlled in this manner.

FIG. 4B illustrates another exemplary publisher queue tuple 260a according to another embodiment where the partitions are specified as separate elements using a “partition” element. In another embodiment (not shown), the publisher's tuple 252 may be partitioned at each element in the same level where support for nesting may be provided. In other embodiments, no indication of allowable partitions is required because any portion of the publisher's tuple 252 that contains a complete element is valid. As those skilled in the art will appreciate, the publisher's tuple 252 may be partitioned in any number of ways, including those discussed above, so long as the distinct tuple element formed by the partitioning is a stand alone entity that does not require additional data from the tuple in order to construct an entity that may be processed by the receiving client 130.

In one exemplary embodiment, the publisher's queue tuple 260a can be implemented as a policy tuple disclosed in co-pending U.S. patent application Ser. No. 11/306,341, entitled “METHODS, SYSTEMS, AND COMPUTER PROGRAM PRODUCTS FOR ASSOCIATING POLICIES WITH TUPLES USING A PUB/SUB PROTOCOL,” filed on Dec. 23, 2005, assigned to the assignee of the present application, and incorporated here by reference in its entirety. According to the above-referenced co-pending patent application, a policy handler stores policy specifications as tuple data in policy tuples. The policy specifications specify a tuple (e.g., the publisher's tuple 252), a condition associated with the specified tuple, and an action associated with the condition. The policy handler includes means for subscribing to the tuple, for receiving a notification when the tuple is updated, for associating the policy tuple with the subscription to the tuple, and for determining if the tuple update satisfies the condition associated with the tuple based on the tuple update notification. The policy handler also includes means for generating, responsive to receiving the notification, a notify message indicating the associated action and for sending the notify message to a policy enforcer for performing the associated action.

Thus, in this exemplary embodiment, the publisher's queue tuple 260a can be a policy tuple that is associated with a subscription to a specified tuple, e.g., the publisher's tuple 252. When the publisher's tuple 252 is updated (the condition associated with the specified tuple), the policy handler receives a notification and generates a notify message indicating the associated action, e.g., that each of the plurality of distinct tuple elements represented by the queue elements 262 be sent to a recipient client 130 in a series of notification messages. The notify message can then be sent to the policy enforcer for performing the associated action.

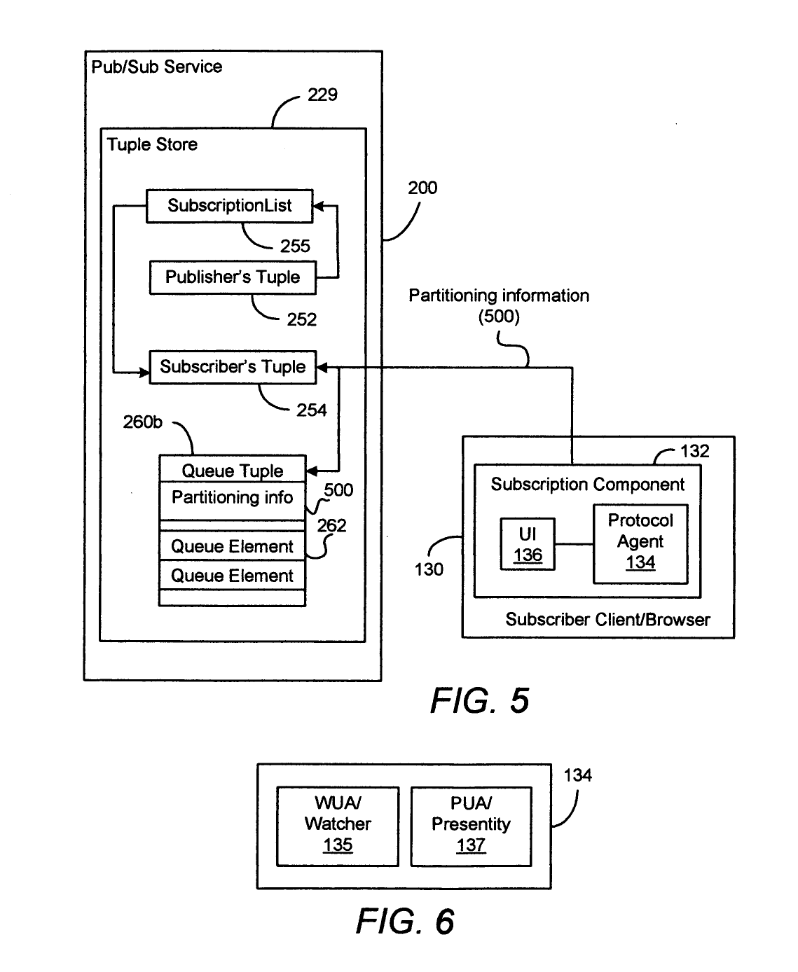

FIG. 5 is a block diagram illustrating another exemplary tuple structure in a system for delivering published information associated with a tuple 250. In this exemplary embodiment, the tuple store 229 includes a publisher's tuple 252 that is related to information published by a publisher 240, 302. The publisher's tuple 252 is associated with a subscription list 255 that references a subscriber's tuple 254 associated with a subscriber client 130 that is subscribed to the information in the publisher's tuple 252. In the embodiment shown in FIG. 5, the subscriber 130 is allowed to specify partitioning parameters and is configured to submit partitioning information 500 to the pub/sub service 200. Here, the subscriber 130 can submit the partitioning information 500 to the pub/sub service 200 using a pub/sub protocol, such as a presence protocol, via the pub/sub protocol agent 134.

FIG. 6 is a block diagram illustrating an exemplary pub/sub protocol agent 134 where the pub/sub protocol used is the presence protocol. As is shown, the protocol agent 134 includes a WUA/watcher component 135 and a PUA/presentity component 137. Alternatively, the subscriber 130 can communicate with the pub/sub service 200 using only the WUA/watcher component 135, as is well known to those skilled in the art.

According to an exemplary embodiment, the partitioning information 500 can define how the published information in the publisher's tuple 252 can be partitioned and also can define which of the distinct tuple elements can be sent to the subscriber client 130, i.e., the entire set or a subset. In addition, the partitioning information 500 can indicate how the plurality of distinct tuple elements can be sent to the subscriber client 130. For example, the partitioning information 500 can specify the order in which each of the distinct tuple elements is sent to the subscriber client 130. In another embodiment, the partitioning information 500 can include information about the client device 120, e.g., the device's type, its storage capacity, or its processing power, etc., and/or information about a user of the device 120, and based on this information, the pub/sub service 200 can determine how the published information can be partitioned and/or presented. For example, the partitioning information 500 can identify a partition class to which the client device 120 belongs and the pub/sub service 200 can determine how to partition the tuple 252 based on the partition class. Devices 120 can be categorized into partition dasses based on device capabilities, such as storage capacity, processing power, display size, and the like, or based on other characteristics associated with the device 120.

In one embodiment, the partitioning information 500 can specify how quickly each notification message related to each of the distinct tuple elements is sent to the subscriber client 130 by utilizing the method and system disclosed in co-pending U.S. patent application Ser. No. 11/306,346, entitled “METHOD AND SYSTEM FOR PRESENTING PUBLISHED INFORMATION IN A BROWSER,” filed on Dec. 23, 2005, assigned to the assignee of the present application and incorporated here by reference in its entirety. For example, the subscriber client 130 can display, via the user interface 136, a user pacing control window that allows the user to control the rate at which the notification messages are sent from the pub/sub service 200 to the subscriber client 130.

According to an exemplary embodiment, the subscriber client 130 can submit the partitioning information 500 via at least one of a publish command, a subscribe command, and a notify command response. For instance, the following are examples of pub/sub and presence commands and responses that include partitioning information 500 using various pub/sub protocols.

### EXAMPLE 2

```
<iq type=“set” from=“sub1@foo.com/home” to=“pubsub.jabber.org”
    id=“sub1”>
    <pubsub xmlns=“http://jabber.org/protocol/pubsub”>
        <subscribe node=“tuple/*/album” jid=“sub1@foo.com”
            partition=”album,image” orderBy”name:asc,subject”/>
    </pubsub>
</iq>
```

Example 2, above, illustrates an XMPP pub/sub subscribe command where a “partition” attribute indicates that the subscriber 130 prefers to partition the published information by “album” and by “image,” and that albums be sent in ascending order by name, and that images be sent in ascending order by subject. The node attribute indicates the subscription is for all album elements in the publisher's tuple 252. Thus, image elements that are outside of album elements will not be included in the subscription. The subscribe command can also include an element that specifies a time interval, e.g., pace setting, between notify commands. In one embodiment, the subscribe command can include an element that merely indicates a preference for partitioned delivery without identifying the partition boundaries.

Example 3, below, illustrates a SIMPLE notify command that provides partitioning information to the subscriber 130, and a SIMPLE notify response from the subscriber 130 that includes partitioning preferences.

### EXAMPLE 3

```
F3 NOTIFY example.com server-> watcher
    NOTIFY sip:user@watcherhost.example.com SIP/2.0
    Via: SIP/2.0/TCP server.example.com;branch=z9hG4bKna998sk
    From: <sip:resource@example.com>;tag=ffd2
    To: <sip:user@example.com>;tag=xfg9
    Call-ID: 2010@watcherhost.example.com
    Event: presence
    Subscription-State: active;expires=599
    Max-Forwards: 70
    CSeq: 8775 NOTIFY
    Contact: sip:server.example.com
    Content-Type: application/cpim-pidf+xml
    Content-Length: ...
    PartitionCount=3.2
    PartitionTotal=12.5
    PartitionBoundary=album/image
    Order=name:asc,default
    [PIDF Document]
F4 200 OK watcher-> example.com server
    SIP/2.0 200 OK
    Via: SIP/2.0/TCP server.example.com;branch=z9hG4bKna998sk;
      received=192.0.2.2
    From: <sip:resource@example.com>;tag=ffd2
    To: <sip:user@example.com>;tag=xfg9
    Call-ID: 2010@watcherhost.example.com
    PartitionCount=6
    CSeq: 8775 NOTIFY
    Content-Length: 0
```

In the notify command of Example 3, the “partition count” can indicate the partition associated with the notify command. For example, the 2^{nd} partition at the second level in the 3^{rd} partition of the 1^{st} level is associated with the notify command. The “partition total” identifies the number of partitions at each level, and the “partition boundary” indicates the partition boundary of the notify command. In addition or alternatively, the notify command can include an element to indicate a first or last notification in a series of notify commands. In the notify response, the subscriber 130 can use the “partition count” to instruct the pub/sub service 200 to skip to the 6^{th} partition at level 1. In addition, the notify response can include a pacing element that specifies a time interval between notify commands.

Example 4, below, illustrates a notify command and response using an RVP presence protocol.

### EXAMPLE 4

>>Request
NOTIFY /instmsg/aliases/maxb HTTP/1.1
Host: im.fabrikamwidgets.com
RVP-Notifications-Version: 0.2
RVP-Ack-Type: DeepOr
RVP-Hop-Count: 1
RVP-From-Principal: http://im.example.com/instmsg/aliases/deriks
Content-Type: text/xml
Content-length: XXXX
RVP-PartitionCount=1.5.2
RVP-PartitionTotal=1.15.6
<?xml version=“1.0”?>
<Z:notification xmlns:D=“DAV:”
xmlns:Z=“http://schemas.microsoft.com/rvp/”>
<Z:message>
.
.
.
</Z:message>
</Z:notification>
>>Response
HTTP/1.1 200 Successful
RVP-Notifications-Version: 0.2
PACE: 5s
RVP-PartitionCount=1.12

In another embodiment, the subscriber 130 can submit partitioning information 500 using a form provided by the pub/sub service 200. For example, in response to receiving a subscribe command from the subscriber 130, the pub/sub service 200 can respond by requiring the subscriber 130 to configure the subscription by completing a partitioning options form. Once completed, the subscriber 130 can send the form back to the pub/sub service 200 for processing. The following exemplary commands using the XMPP pub/sub protocol illustrate this embodiment:

### EXAMPLE 5

```
(Subscriber subscribes to a node)
<iq type=“set” from=“sub1@foo.com/home” to=“bigpublisher.com” id=“sub1”>
    <pubsub xmlns=“http://jabber.org/protocol/pubsub”>
        <subscribe node=“generic/book” jid=“sub1@foo.com”/>
    </pubsub>
</iq>
(Service replies with success and indicates that subscription configuration
is required)
<iq type=“result” from=“pubsub.jabber.org” to=“sub1@foo.com/home”
        id=“sub1”>
    <pubsub xmlns=“http://jabber.org/protocol/pubsub”>
        <entity node=“generic/book” jid=“sub1@foo.com” affiliation=“none”
                subid=“123-abc” subscription=“unconfigured”>
            <subscribe-options>
                <required/>
            </subscribe-options>
        </entity>
    </pubsub>
</iq>
(Subscriber requests subscription options form)
<iq type=“get” from=“sub1@foo.com/home” to=“pubsub.jabber.org”
                id=“options1”>
        <pubsub xmlns=“http://jabber.org/protocol/pubsub”>
                <options node=“generic/book” subid=“123-abc”
                        jid=“sub1@foo.com”/>
        </pubsub>
</iq>
(Service responds with the options form)
<iq type=“result” from=“pubsub.jabber.org” to=“sub1@foo.com/home”
    id=“options1”>
    <pubsub xmlns=“http://jabber.org/protocol/pubsub”>
        <options node=“generic/media” jid=“sub1@foo.com” subid=“123-
            abc”>
            <x xmlns=“jabber:x:data”>
                <field var=“FORM_TYPE” type=“hidden”>
                    <value>http://jabber.org/protocol/pubsub#subscribe_options
                    </value>
                </field>
                <field var=“pubsub#digest” type=“boolean”
                        label=“Receive digest notifications (approx. one per day)”>
                    <value>0</value>
                </field>
                <field var=“pubsub#partitioning” type=“list-nested-multi”
                        label=“Select the partition boundaries for sending tuple
                        elements in parts:”>
                    <option label=“Folio”><value>folio</value>
                        <field var=“pubsub#partition-folio-orderAttr” type=“list”
                                    label=“Select the ordering:”>
                            <option label=”By Name”><value>name</value>
                            </option>
                            <option label=”By Date Created”>
                                <value>dateCreated</value>
                            </option>
                        </field>
                        <field var=“pubsub#partion-folio-orderDirection” type=“list”
                                label=“Select the ordering:”>
                            <option label=”Ascending”><value>asc</value></option>
                            <option label=”Descending”>
                                <value>desc</value
                            </option>
                        </field>
                        ...
                    </option
                    ...
                </field>
            </x>
        </options>
    </pubsub>
</iq>
(Subscriber returns completed options form)
<iq type=“set” from=“sub1@foo.com/home” to=“pubsub.jabber.org”
        id=“options2”>
    <pubsub xmlns=“http://jabber.org/protocol/pubsub”>
        <options node=“generic/media” jid=“sub1@foo.com” subid=“123-abc”>
            <x xmlns=“jabber:x:data”>
                <field var=“FORM_TYPE” type=“hidden”>
                    <value>http://jabber.org/protocol/pubsub#subscribe_options
                    </value>
                </field>
                <field var=“pubsub#digest” type=“boolean”><value>0</value>
                </field>
                <field var=“pubsub#partitioning” type=“list-multi”
                        value=”folio:name:asc,album,creationDate:asc”/>
                ...
            </x>
        </options>
    </pubsub>
</iq>
(Service responds with success)
<iq type=“result” from=“pubsub.jabber.org” to=“sub1@foo.com/home”
id=“options2”/>
```

In one embodiment, the subscriber's partitioning information 500 can be stored in the subscriber's tuple 254 or in another embodiment, in a subscriber queue tuple 260b. If the subscriber 130 has subscribed to more than one tuple, the subscriber 130 can provide partitioning information 500 for each subscription by associating a subscriber queue tuple 260b with a subscription. Similar to the publisher queue table 260a, the subscriber queue tuple 260b can be a data tuple that includes a plurality of queue elements 262, each of which represents one of the distinct tuple elements defined by the partitioning information 500. Each queue element 262 can include the portion of the published information corresponding to the distinct tuple element or a reference, such as a URI, to the portion of the published information.

As with the publisher's queue tuple 260a, the queue elements 262 in the subscriber queue tuple 260b are associated with the most recent update of the tuple 252. If a new update to the tuple 252 occurs before all the queue elements 262 have been sent, the queue may be purged in one embodiment and new queue elements 262 may be placed in the queue so that the recipient client 130 is sent only current information. In an alternate embodiment, the queue elements 262 may be sent when a new update is received but before the new update is processed. If more than one update to the tuple 252 occurs while the subscriber queue tuple 260 is being processed, only the last update will be used to create the next queue of elements because the intermediate updates are no longer current. In a further alternate embodiment, the queue elements 262 may be replaced by the latest versions of those elements when a new update is received, then the subscriber queue tuple 260b can be repopulated with all the distinct elements to be sent when an update occurs, so that the recipient client 130 has all the latest data.

In one exemplary embodiment, like the publisher's queue tuple 260a, the subscriber queue tuple 260b can also be implemented as a policy tuple disclosed in the co-pending U.S. patent application Ser. No. 11/306,341, entitled “METHODS, SYSTEMS, AND COMPUTER PROGRAM PRODUCTS FOR ASSOCIATING POLICIES WITH TUPLES USING A PUB/SUB PROTOCOL,” described and discussed above. For the sake of brevity, that discussion will not be repeated here.

In the embodiment illustrated in FIG. 3, the publisher 240, 302 controls the partitioning information 310, whereas in the embodiment illustrated in FIG. 5, the subscriber 130 controls the partitioning information 500. In other embodiments, combinations of each are possible. For example, both the subscriber 130 as well as the publisher 240, 302 may share control over the partitioning information. In another embodiment, where there is a conflict, the publisher's preferences can override the subscriber's preferences, or vice versa. In another embodiment, the pub/sub service 200 can control the partitioning information.

It should be understood that the various components illustrated in the figures represent logical components that are configured to perform the functionality described herein and may be implemented in software, hardware, or a combination of the two. Moreover, some or all of these logical components may be combined and some may be omitted altogether while still achieving the functionality described herein.

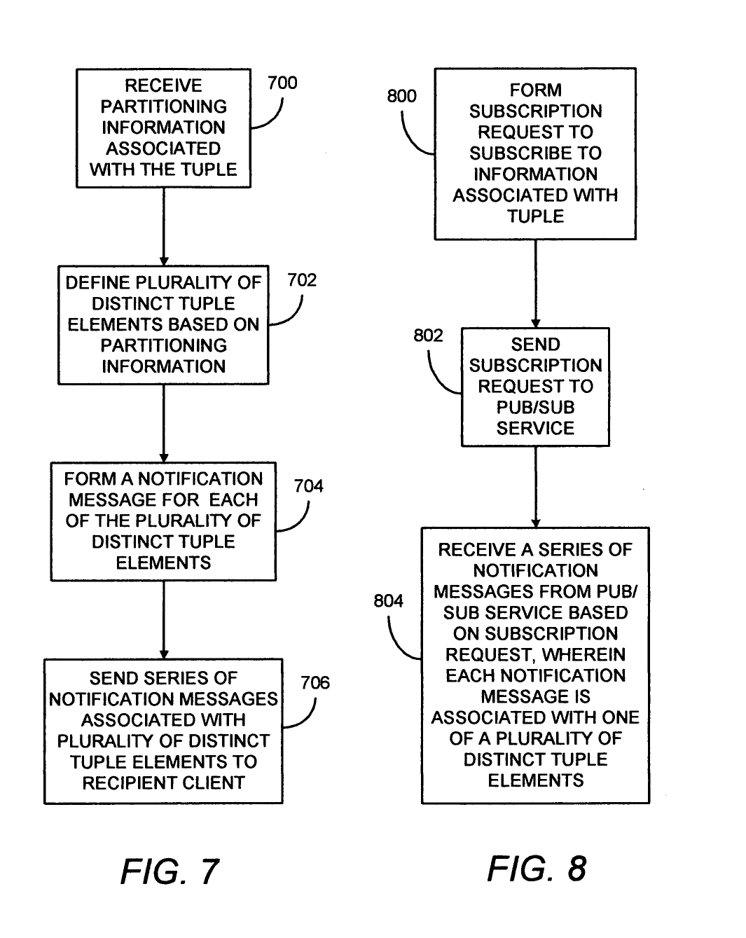

FIG. 7 is a flow diagram illustrating a method for delivering published information associated with a tuple using a pub/sub protocol according to an exemplary embodiment. Referring to FIGS. 2, 3, 5 and 7, partitioning information associated with a tuple is received by the pub/sub service 200 in block 700. For example, the partitioning information can be sent from the subscriber 130, the publisher 240, 302, or both, and is associated with the publisher's tuple 252. The partitioning information includes any specifications to customize the organization and delivery of the published information associated with the tuple. In one embodiment, the partitioning information can include at least one of the following: an indication as to how the published information in the tuple 252 should be partitioned, the order in which the published information should be delivered to the recipient client 130, a time interval between the sending of each portion, a characteristic of a recipient device 120 and information related to a recipient user.

In block 702, a plurality of distinct tuple elements is defined based on the partitioning information. For example, the subscription manager 224 and/or publication manager 226 can process the partitioning information and coordinate with the tuple manager 228 to define the plurality of distinct tuple elements. Each distinct tuple element is related to a portion of the published information associated with the publisher's tuple 252. In one embodiment, the publisher's tuple 252 comprises a set of tuple elements and the plurality of distinct tuple elements is selected from the set of tuple elements such that the plurality of distinct tuple elements is a subset of the set.

The pub/sub service 200 forms a notification message for each of the plurality of distinct tuple elements in block 704 and sends each of the notification messages to the recipient client 130 in block 706. In one embodiment, a notification message can include the portion of the published information corresponding to the distinct tuple element associated with the notification message. In another embodiment, the notification message can include an identifier that references the portion of the published information, as is shown in the following exemplary notification messages:

### EXAMPLE 6

```
<message to=“subscriber1” from=“bigpublisher.com”>
    <event xmlns=“http://jabber.org/protocol/pubsub#event”
            partitionCount=”2.3” partitionTotal=”2.12”>
        <items node=“generic/book”>
            <item id=“chapter3”/>
                <book xmlns=“http://jabber.org/protocol/book”>
                    <chapter title=”I Return Home”
                            source=”http://bigpublisher.com/
                            book1/chapter3.pdf”/>
                </book>
            </item>
        </items>
    </event>
</message>
<message to=“subscriber1” from=“bigpublisher.com”>
    <event xmlns=“http://jabber.org/protocol/pubsub#event
                partitionCount=”2.4” partitionTotal=”2.12”>
        <items node=“generic/books/book1/chapter4”>
            <item id=“chapter4”/>
                <book xmlns=“http://jabber.org/protocol/book”>
                    <chapter title=”I Am Not Welcome”
                            source=”http://bigpublisher.com/book1/
                            chapter4.pdf”/>
                </book>
            </item>
        </items>
    </event>
</message>
```

### EXAMPLE 7

```
<message to=“subscriber1” from=“bigpublisher.com”>
    <event xmlns=“http://jabber.org/protocol/pubsub#event”
                partitionCount=”2.3” partitionTotal=”2.12”>
        <items node=“generic/book”>
            <item id=“chapter3”/>
        </items>
    </event>
</message>
<message to=“subscriber1” from=“bigpublisher.com”>
    <event xmlns=“http://jabber.org/protocol/pubsub#event
                partitionCount=”2.4” partitionTotal=”2.12”>
        <items node=“generic/book”>
            <item id=“chapter4”/>
        </items>
    </event>
</message>
```

FIG. 8 is a flow diagram illustrating a method for receiving information associated with a tuple using a pub/sub protocol according to an exemplary embodiment. In block 800, a subscriber client 130 forms a subscription request to subscribe to information associated with the publisher's tuple 252, and in block 802 sends the subscription request to the pub/sub service 200. In one embodiment, the subscription request includes partitioning information. In another embodiment, the pub/sub service 200, in response to receiving the subscription request, provides a form that allows the subscriber 130 to designate the partitioning information, which when completed is sent back to the pub/sub server 200. As described above, the partitioning information can be used to determine how the published information is partitioned and how it is provided to the subscriber 130.

In block 804, the subscriber 130 receives a series of notification messages from the pub/sub service 200 based on the subscription to the publisher's tuple 252. Each of the notification messages is associated with one of a plurality of distinct tuple elements and each distinct tuple element is related to a portion of the published information associated with the tuple 252. In one embodiment, a notification message includes an identifier that references the portion of the published information, and the subscriber 130 can use the identifier to retrieve the portion of the published information.

The subscriber 130 can receive the series of notification messages in response to the subscription request and also in response to an update to the tuple 252. In the latter case, at least one of the notification messages can be associated with a distinct tuple element that has not been updated.

The executable instructions of a computer program as illustrated in FIG. 7 and FIG. 8 can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium.

More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Methods for delivering and receiving published information associated with a tuple using a pub/sub protocol have been described. In one embodiment, the tuple is partitioned into a plurality of distinct tuple elements, where each distinct tuple element is related to a distinct portion of the published information. The partitioning is based on partitioning information provided by a subscriber 130, a publisher 240, 302, or both. When appropriate, e.g., when the tuple is updated or when a subscription request or fetch is received, the portions of the published information related to the plurality of distinct tuple elements can be sent to a recipient client 130, e.g., the subscriber 130, according to a subscription or to a directed publish/notify command. In particular, a series of notification messages is sent to the recipient client 130 where each notification message is associated with one distinct tuple element.

By allowing the subscriber 130 and the publisher 240, 302 to submit partitioning information that defines how the published information can be partitioned and provided to the recipient client 130, the delivery and processing of the published information can be customized to suit the needs of the subscriber 130 and/or publisher 240, 302. For example, if the subscriber device 120 has limited resources, e.g., memory and/or processing power, the portion of the published information associated with each of the plurality of notification messages can be adjusted such that the subscriber device 120 can process the information more efficiently. In another example, if the published information is processed in a certain order and if an error in the processing results in the end of processing, unprocessed distinct tuple elements need not be sent, thereby saving time and reducing traffic.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for delivering published information associated with a tuple using a publish/subscribe communication protocol, the method comprising:
receiving partitioning information associated with the tuple;
defining a plurality of distinct tuple elements each related to a portion of the published information associated with the tuple based on the received partitioning information; and
sending a series of notification messages to a recipient client, each notification message being associated with one of the plurality of distinct tuple elements for providing each related portion of the published information to the recipient client.

2. The method of claim 1 further comprising forming a notification message associated with one of the plurality of distinct tuple elements by including the portion of the published information related to the one distinct tuple element in the notification message.

3. The method of claim 1 further comprising forming a notification message associated with one of the plurality of distinct tuple elements by including an identifier that references the portion of the published information related to the one distinct tuple element in the notification message.

4. The method of claim 1 further comprising associating the plurality of distinct tuple elements with a subscription and wherein sending the series of notification messages is pursuant to the subscription.

5. The method of claim 1 wherein the partitioning information is provided by a publisher associated with the tuple and includes at least one of an order in which each of the notification messages in the series of notification messages is to be sent and an indication of how the plurality of distinct tuple elements is to be defined.

6. The method of claim 1 wherein the partitioning information is included in a subscription request to the tuple and includes at least one of: an indication of how the plurality of distinct tuple elements is to be defined, an order in which each of the notification messages in the series of notification messages is to be sent, a time interval between the sending of each notification, a characteristic of a device to which the series of notification messages is to be sent, and information related to a subscriber to which the series of notification messages is to be sent.

7. The method of claim 1 further including:
in response to receiving a request from a subscriber to subscribe to the tuple, sending a form to the subscriber that allows the subscriber to provide the partitioning information.

8. The method of claim 1 further comprising:
receiving an update to the tuple from a publisher;
updating the tuple; and
sending the series of notification messages each associated with one of the plurality of distinct tuple elements for providing each corresponding portion of the published information to the recipient device.

9. The method of claim 8 wherein receiving the partitioning information, receiving the update, and sending the notifications is performed using a publish/subscribe communication protocol.

10. The method of claim 8 wherein at least one of the notification messages in the series of notification messages includes published information that has not been modified by the update to the tuple.

11. The method of claim 1 wherein the tuple comprises a set of tuple elements and wherein defining the plurality of distinct tuple elements includes:
selecting the plurality of distinct tuple elements from the set of tuple elements based on the partitioning information, wherein the selected plurality of distinct tuple elements is a subset of the set of tuple elements.

12. A method for receiving information associated with a tuple using a publish/subscribe communication protocol, the method comprising:
forming a subscription request to subscribe to the information associated with the tuple;
sending the subscription request to a publish/subscribe service that manages the tuple; and
receiving a series of notification messages from the publish/subscribe service based on the subscription request,
wherein each notification message is associated with one of a plurality of distinct tuple elements, each of which is related to a portion of the published information associated with the tuple.

13. The method of claim 12 wherein a received notification message includes the portion of the published information related to the one distinct tuple element associated with the received notification message.

14. The method of claim 12 wherein a received notification message includes an identifier that references the portion of the published information related to the one distinct tuple element associated with the received notification message.

15. The method of claim 14 further comprising using the identifier to retrieve the portion of the published information related to the one distinct tuple element associated with the received notification message.

16. The method of claim 12 wherein forming the subscription request includes providing partitioning information that is used to define the plurality of distinct tuple elements.

17. The method of claim 16 wherein forming the subscription request includes receiving from the publish/subscribe service a form that allows a subscriber to provide the partitioning information, and sending the partitioning information to the publish/subscribe service.

18. The method of claim 16 wherein the partitioning information includes at least one of: an indication of how the plurality of distinct tuple elements is to be defined, an order in which each of the notification messages in the series of notification messages is to be sent, a time interval between the sending of each notification, a characteristic of a device to which the series of notification messages is to be sent, and information related to a subscriber to which the series of notification messages is to be sent.

19. The method of claim 12 wherein the tuple comprises a set of tuple elements, and wherein forming the subscription request includes providing partitioning information to identify the plurality of distinct tuple elements from the set of tuple elements, wherein the identified plurality of distinct tuple elements is a subset of the set of tuple elements.

20. The method of claim 12 wherein sending the subscription request and receiving the series of notification messages are performed using a publish/subscribe communication protocol.

21. The method of claim 12 wherein receiving the series of notification messages includes receiving a notification message that is associated with a distinct tuple element that has not been modified by a most recent update to the tuple.

22. A system for delivering published information associated with a tuple using a publish/subscribe communication protocol, the system comprising:
a publisher configured to publish information associated with the tuple;
a recipient client configured to receive the published information; and
a publish/subscribe service configured to receive partitioning information associated with the tuple, to define a plurality of distinct tuple elements each related to a portion of the published information associated with the tuple based on the received partitioning information, and to send to the recipient client a series of notification messages each associated with one of the plurality of distinct tuple elements for providing each related portion of the published information to the recipient client.

23. The system of claim 22 wherein a notification message associated with one of the plurality of distinct tuple elements includes the portion of the published information related to the one distinct tuple element in the notification message.

24. The system of claim 22 wherein a notification message associated with one of the plurality of distinct tuple elements includes an identifier that references the portion of the published information related to the one distinct tuple element in the notification message.

25. The system of claim 22 wherein the recipient client is configured to submit a subscription to the tuple, and wherein the publish/subscribe service is configured to associate the plurality of distinct tuple elements with the subscription and to send the series of notification messages pursuant to the subscription.

26. The system of claim 22 wherein the partitioning information is provided by the publisher and includes at least one of an order in which each of the notification messages in the series of notification messages is to be sent and an indication of how the plurality of distinct tuple elements is to be defined.

27. The system of claim 22 wherein the publisher is configured to publish updated information associated with the tuple and wherein in response to receiving the updated information, the publish/subscribe service is further configured to update the tuple and to send to the recipient client a series of notification messages associated with each of the plurality of distinct tuple elements in response to updating the tuple, regardless of whether any of the plurality of distinct tuple elements is modified by the update to the tuple.

28. The system of claim 22 wherein the partitioning information is provided by the recipient client and includes at least one of: an indication of how the plurality of distinct tuple elements is to be defined, an order in which each of the notification messages in the series of notification messages is to be sent, a time interval between the sending of each notification, a characteristic of a device to which the series of notification messages is to be sent, and information related to a subscriber to which the series of notification messages is to be sent.

29. The system of claim 22 wherein the tuple comprises a set of tuple elements and wherein the publish/subscribe service is configured to define the plurality of distinct tuple elements by selecting the plurality of distinct tuple elements from the set of tuple elements based on the partitioning information, wherein the selected plurality of distinct tuple elements is a subset of the set of tuple elements.

30. A system for delivering published information associated with a tuple using a publish/subscribe communication protocol, the system comprising:
means for publishing information associated with the tuple;
means for defining a plurality of distinct tuple elements each related to a portion of the published information associated with the tuple based on partitioning information; and
means for sending to a recipient client a series of notification messages each associated with one of the plurality of distinct tuple elements for providing each related portion of the published information to the recipient client.

31. A system for receiving information associated with a tuple using a publish/subscribe communication protocol, the system comprising:
means for forming a subscription request to subscribe to the information associated with the tuple;
means for providing partitioning information related to the tuple in the subscription request;
means for sending the subscription request to a publish/subscribe service that manages the tuple; and
means for receiving a series of notification messages from the publish/subscribe service based on the subscription request, wherein each notification message is associated with one of a plurality of distinct tuple elements, each of which is related to a portion of the published information associated with the tuple.

32. A device for receiving information associated with a tuple using a publish/subscribe communication protocol, the device comprising:
a subscription client component configured to form a subscription request to subscribe to the information associated with the tuple and to include partitioning information related to the tuple in the subscription request; and
a network stack component configured to send the subscription request and partitioning information to a publish/subscribe service that manages the tuple, and to receive a series of notification messages from the publish/subscribe service based on the subscription request,
wherein the partitioning information is used to define a plurality of distinct tuple elements, each of which is related to a portion of the published information associated with the tuple, and wherein each notification message is associated with one of the plurality of distinct tuple elements.

33. The device of claim 32 wherein a received notification message includes the portion of the published information related to the one distinct tuple element associated with the received notification message.

34. The device of claim 32 wherein a received notification message includes an identifier that references the portion of the published information related to the one distinct tuple element associated with the received notification message.

35. The device of claim 32 wherein the partitioning information includes at least one of: an indication of how the plurality of distinct tuple elements is to be defined, an order in which each of the notification messages in the series of notification messages is to be sent, a time interval between the sending of each notification, a characteristic of the device to which the series of notification messages is to be sent, and information related to a subscriber to which the series of notification messages is to be sent.

36. The device of claim 32 wherein the subscription client includes a subscription component configured to send the subscription request and to receive the series of notification messages using a publish/subscribe communication protocol.

37. The device of claim 32 wherein the subscription client is configured to process the series of notification messages received in response to a most recent update to the tuple, regardless of whether any of the notification messages is associated with any of the plurality of distinct tuple elements modified by the most recent update to the tuple.

38. A computer readable medium containing program instructions for delivering published information associated with a tuple using a publish/subscribe communication protocol, the program instructions for:
receiving partitioning information associated with the tuple;
defining a plurality of distinct tuple elements each related to a portion of the published information associated with the tuple based on the received partitioning information; and
sending a series of notification messages each associated with one of the plurality of distinct tuple elements for providing each related portion of the published information to a recipient device.

39. The computer readable medium of claim 38 further comprising instructions for:
receiving an update to the tuple from a publisher;
updating the tuple; and
sending to the recipient device a series of notification messages associated with each of the plurality of distinct tuple elements, regardless of whether any of the plurality of distinct tuple elements has been updated.

40. A computer readable medium containing program instructions for receiving information associated with a tuple using a publish/subscribe communication protocol, the program instructions for:
forming a subscription request to subscribe to the information associated with the tuple;
sending the subscription request to a publish/subscribe service that manages the tuple; and
receiving a series of notification messages from the publish/subscribe service based on the subscription request,
wherein each notification message is associated with one of a plurality of distinct tuple elements, each of which is related to a portion of the published information associated with the tuple.
